(19) United States
(12) Patent Application Publication
(10) Pub. No.: US 2012/0124162 A1
(43) Pub. Date: May 17, 2012

(54) METHOD AND APPARATUS FOR SELECTING MEDIA CONTENT IN A MOBILE COMMUNICATIONS DEVICE

(75) Inventor: Brendon P. Cassidy, Los Angeles, CA (US)

(73) Assignee: CRICKET COMMUNICATIONS, INC.

(21) Appl. No.: 13/158,321

(22) Filed: Jun. 10, 2011

Related U.S. Application Data
(60) Provisional application No. 61/353,606, filed on Jun. 10, 2010.
(60) Provisional application No. 61/394,209, filed on Oct. 18, 2010.
(60) Provisional application No. 61/394,222, filed on Oct. 18, 2010.
(60) Provisional application No. 61/430,124, filed on Jan. 5, 2011.
(60) Provisional application No. 61/425,192, filed on Dec. 20, 2010.

(51) Int. Cl. G06F 15/16

(52) U.S. Cl. 709/217

(57) ABSTRACT

A mobile device includes a media application to allow a user to access and play stored media files. A setup procedure within the media application receives preference information from a user that is used by a content source to select a library of media files. In one embodiment, one or more of the selected media files are downloaded to the mobile device in a manner that minimizes battery drain on the mobile device and/or communication bandwidth.

This application claims priority under 35 U.S.C. §119(e) to Provisional Patent Application No. 61/353,606 entitled “Unlimited Media Access Over Wireless Infrastructure” filed Jun. 10, 2010, to Provisional Patent Application No. 61/394,209 entitled “Mobile Handset For Media Access And Playback filed Oct. 18, 2010, to Provisional Patent Application No. 61/394,222 entitled “Media Server Providing Unlimited Media Access Over Wireless Infrastructure” filed Oct. 18, 2010, and to Provisional Patent Application No. 61/430,124 entitled “Method And Apparatus For Selecting Media Content In A Mobile Communication Device” filed Jan. 5, 2011, the contents of all four of which are incorporated herein by reference.

### TECHNICAL FIELD

The disclosed technology relates to media playback systems for mobile devices.

### BACKGROUND

In addition to allowing a user to make and receive calls, many mobile communications devices now allow users to perform other functions, such as reading and drafting e-mails, accessing the Internet, running small programs, and viewing or playing media files. Media files that are stored on a user's mobile communications device typically are either copied from physical sources (e.g., CDs) that are owned by the user or purchased from an online media store.

A media archive is typically empty or contains only a token number of items when it is started. The media archive is then gradually expanded as new items of media, e.g. songs, are acquired and added to the archive. In some instances, an existing archive can be copied, e.g. from another person or from another device. However, the existing archive also is expanded only through the acquisition of additional items of media.

### SUMMARY

The technology disclosed herein is a system and method for selecting a library of media files to download from a content source to a computing device, such as a mobile communications device. In some implementations, an initial library is selected based on one or more indicated preferences of a user. In other implementations, a media application on the mobile device prompts the user for preference information that can include any or all of artist names, genres, negative preferences, and other preference information. The preference information can be forwarded by the computing device to a content source, which can select a number of media files to populate the initial library based on one or more of the indicated preferences. The selected media files can then be downloaded to the computing device for local storage and play. Media content can include any or all of audio (e.g., music), video (e.g., movies, shorts), text-based content (e.g., e-books), or any combination thereof.

The initial library of media files can be downloaded in a manner that reduces the battery power and/or bandwidth, e.g. cellular bandwidth, used by a computing device. The selected media files can be downloaded to the mobile device when the device is connected to an external power supply. Also, the selected media files can be downloaded when the mobile device is connected to the content source via a non-cellular communications link, such as a wired network connection or a Wi-Fi connection. Further, media files can be downloaded when the mobile device is not performing other communications operations, such as conducting a telephone call or transferring data to/from a remote source.

A media application program running on a mobile device also can record data indicative of media files that are frequently played by the user or are highly ranked. Such data can be transmitted to the content source and used in conjunction with other data, such as previously received preference information or data indicative of media files downloaded from the content source, in order to update the initial library that is stored on the mobile device. Further, in some implementations, the content source can be a music subscription service that allows a subscriber to access and/or download media files as long as a subscription is active.

By using the described technology to populate the initial media library on a newly provisioned computer device (e.g., a mobile device), a user of the computing device can quickly add media content on the newly provisioned computing device before learning how to get use a media distribution system. Accordingly, the described technology allows new users of the media distribution system to obtain and access media content instantly. Various examples of quickly and instantly populating the initial media library can include subscribing to a DJ play list and pre-connecting to other user's play list, etc. These and other examples are described further in the detailed description and accompanying figures.

### BRIEF DESCRIPTION OF THE DRAWINGS

FIG. 1 illustrates a media distribution system in accordance with one embodiment of the disclosed technology.

FIG. 2 illustrates an exemplary mobile device in accordance with an implementation of the disclosed technology.

FIG. 3 illustrates a number of interface screens associated with a media application in accordance with an implementation of the disclosed technology.

FIGS. 4A and 4B illustrate interface screens used to select and download an initial library of media files in accordance with an implementation of the disclosed technology.

FIG. 5 shows a flow chart of steps performed in accordance with an implementation of the disclosed technology for selecting and downloading an initial library of media files.

### DETAILED DESCRIPTION

The described technology can allow a media distribution system subscriber to populate his/her local media archive automatically, by specifying one or more preferences. The features of the described technology can be launched from a computing device, such as a mobile device, at any time including during new account set-up when the mobile device is first provisioned for a new subscriber or when a media content distribution service (see, e.g., Unlimited Musik described below) is added to an account). Based on the specified preferences, the Unlimited Musik system can automatically transfer content to the subscriber's mobile device. This permits the discovery of new content to begin as soon as an account is established.

The features of the described technology can be launched automatically, such as upon first accessing the Unlimited Musik application. Additionally or alternatively, the features of the described technology can be launched in response to a user command.

Upon launch of the described technology, various user interfaces can be displayed on the mobile device to receive input from the user. For example, preference data can be collected from the subscriber. Also, various user interfaces can be displayed on the mobile device to prompt the subscriber to identify one or more favorite artists and one or more preferred genres. Other preferences also can be specified, such as favorite albums, favorite songs, and favorite time periods. Negative preferences also can be identified, such as “nothing before 1990” and “No Country.”

Any step in the process can be skipped. For instance, if a subscriber does not want to specify any artists, the user can elect to skip that step. Also, the subscriber can return to previous user interface screens, e.g. to change preferences or to specify additional preferences. In some implementations, the number of preferences that can be specified, in total and/or for a given category, can have an upper limit. In some other implementations, the number of preferences that can be specified within a category and/or in total can be unlimited.

The preferences can be customized, such that a subscriber can enter any data in a preference field. In some implementations, auto-completion, suggestions, or spelling correction can be performed for unrestricted text entry. Alternatively or additionally, the preferences can be guided. For instance, the list of available choices can be presented, e.g., in a drop-down menu format, or can be enforced through auto-completion. For example, a subscriber can enter the first letter of an artist name and all matching artists available in the Unlimited Musik archive can be presented. The list of choices can the be further narrowed through the addition of other letters in the artist name.

The described technology also can be configured to permit the subscriber to initialize one or more profile settings. For instance, the subscriber can set his/her username and add a photograph through a corresponding user interface.

Artificial intelligence can be used to select content to be transferred to the subscriber's local media archive based on the specified preferences. For instance, one or more songs associated with the specified artists can be selected for transfer, e.g., the most popular songs. Further, additional content that correlates with the selected content also can be transferred. For example, for each song/artist specified, it can be determined what other songs/artists also are typically downloaded by subscribers. That content also can be automatically transferred to the subscriber's local media archive. Also, for each genre specified, a mix of content within that genre can be selected for transfer.

The transfer can be conducted in stages. For instance, some content that corresponds directly to express selections can be transferred immediately, so that the subscriber can begin accessing the media content. Additional content can be transferred subsequently, e.g., based on one or more identified factors. For instance, content can be transferred when one or more of the following conditions are detected: (i) the mobile device is connected to an external power source, (ii) the mobile device is not in use; (iii) network traffic is below a threshold level; (iv) it is a predetermined time of day and/or day of the week; (v) there is no expressly requested content to transfer; and (vi) the local archive is below a predetermined size threshold.

The amount of system provided content also can be restricted. For instance, a threshold of 50% of capacity can be set, such that the subscriber has available storage space for content they expressly request.

These and other aspects of the described technology are described further below with respect to accompanying figures. Only a few exemplary implementations are described to illustrate the technology using non-limiting examples.

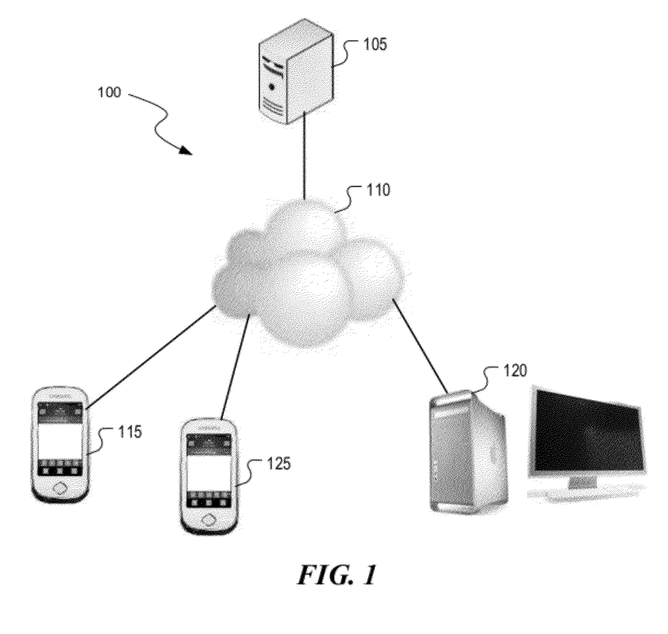

FIG. 1 shows an exemplary computing environment in which a library of media files can be selected and transferred to a mobile device. Computing environment 100 can include a server 105 (or “the cloud”) configured to operate as a content source that provides access to and management of media content. Server 105 can be implemented using a single computing device or multiple computing devices, which can be co-located or distributed across two or more locations. For instance, in some implementations, server 105 can be implemented using one or more application servers, web servers, and data servers, which can be housed in one or more locations.

Server 105 can host one or more applications configured to manage subscribing users. For instance, server 105 can be configured to validate a mobile device before the device is authorized to perform media related functions, including accessing locally stored media and downloading media from server 105. Further, server 105 can maintain an instance of one or more user accounts, including user account details, e.g. mobile identification number and subscriber name, locally stored music, subscribed play lists, managed play lists, play back history, and contacts. Server 105 also can host a media catalog (or media archive), which can be accessed through a subscribing mobile device in order to select media for download to the mobile device. Additionally, server 105 can be configured to manage the transfer of music or other media to one or more subscribing mobile devices, including the transfer of specifically requested media and the automated transfer of media based on a subscription, e.g. to a play list.

Server 105 can be adapted to communicate with subscribing users over a network 110, which can be implemented using one or more data networks. For instance, network 110 can include either or both of wired and wireless communication links. Further, network 110 can be a public network, e.g. the internet, a private network, e.g. a cellular data network, or a combination thereof. Network 110 also can include one or more gateways, which facilitate the transfer of data between devices using different protocols. Further, network 110 can include either or both of secure links and unsecure links. Additionally, network 110 can include network infrastructure provided by multiple parties, such as a host network and one or more partner networks, e.g. roaming partners.

Mobile device 115, which is associated with a subscribing user, also can be configured to communicate over network 110, e.g. with server 105 and with other mobile devices 125. In some implementations, the other mobile devices 125 need not be associated with other subscribing users. Any number of mobile devices 115 can be included in computing environment 100. As the number of mobile devices 115 increases, server 105 and network 110 can be scaled, e.g. by adding additional resources, to provide an acceptable level of service. The mobile device 115 can be any mobile device configured to communicate over the network 110 with a host service provider, e.g. server 105. For instance, the mobile device 115 can be a mobile communications device such as mobile cellular telephone that is adapted to transmit and receive data communications, e.g., a smart phone, an MP3 or other dedicated media player such as an Apple iPod or Microsoft Zune, a hand-held gaming device, a personal digital assistant, a tablet computing device, a mini-computer, a micro-computer, a notebook computer, a laptop, or any other such computing device.

The mobile device 115 further can include a non-transitory, computer readable data storage device configured to receive and store media content as well as store programmed instructions for providing a media application program as will be described below. The data storage device can be adapted to provide secure storage for the media content, as well as to perform digital rights management functions, e.g. decrypting media content for playback on the mobile device 115. In some implementations, the data storage device can be a removable device, e.g. a flash memory module. Thus, a local media library can be stored across multiple data storage devices, which can be swapped to provide access to different portions of the library. Also, the mobile device 115 can be powered by a battery that is rechargeable by connecting the device to an external power supply, such as a wall charger, a USB cable, or the like.

The mobile device 115 also can include a display, e.g. a liquid crystal display (LCD) or a light emitting diode (LED) display, and one or more user input devices, such as a touch screen (resistive or capacitive), a touch pad, one or more buttons, one or more keys, a scroll wheel, a dial, a switch, a microphone, a built-in camera or any other such input device. Further, the mobile device 115 can be adapted to communicate using one or more protocols, such as 3G, 4G, Wi-Fi, Wi-Max or other such protocols. For instance, the mobile device 115 can be configured to communicate over Wi-Fi when possible and otherwise to use a 3G or 4G connection.

Additionally, computing environment 100 can include one or more computing systems 120. A computing system 120 can be implemented using a computing device, such as a desktop computer, a laptop computer, a notebook computer, a net book, a tablet computing device, a workstation, and a server. Computing system 120 also can be configured to transmit and receive data over network 110, e.g. over a TCP/IP connection. Thus, computing system 120 can be adapted to provide data communications with server 105. For instance, computing system 120 can be used to perform functions relating to a subscribing user's account, such as account management and the selection of media.

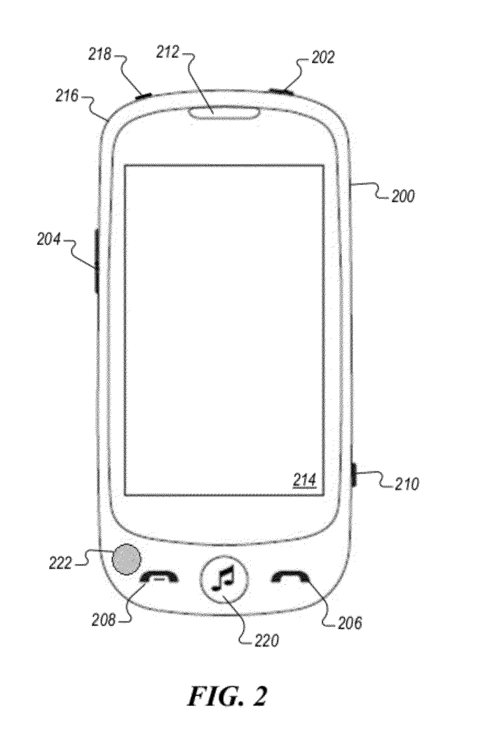

FIG. 2 shows an exemplary mobile device. Mobile device 200 can be configured to provide wireless voice communication and data communication. The device 200 can include physical controls, e.g. a power button 202, a volume control 204, a phone button 206, an end call button 208, and a camera button 210. Further, the device 200 can include outputs, such as speaker 212 and display 214, which can be a touch sensitive display, e.g. resistive or capacitive. Display 214 can be configured to sense either or both of simple gestures (touching, swiping) and complex gestures, such as multi-touch gestures.

In some implementations, the mobile device 200 also can include one or more additional speakers 216 to provide for additional audio output. The one or more speakers can be located on any or all of the peripheral edges, the back, and the front of the device 200. One or more of the included speakers, e.g. the one or more speakers 216, can be used to implement audio playback and/or speakerphone functionality. An accessory jack 218, e.g. for headphones, also can be included. Further, the device 200 can have an integrated digital signal processor (DSP) that can provide for customized tuning of audio output. For example, the DSP can be adapted to provide a graphic equalizer, e.g. a five-band equalizer, to allow pinpoint sound control, and a dynamics processor to provide multi-band compression and limiting. One or more preconfigured options and one or more custom options can be used to specify the audio levels for each of the equalizer's bands. Compression can be configurable using predetermined levels, e.g. off, low, medium and high, which can correspond to software configured bundles of parameters for the compressor's various level, ratio, attack and decay parameters for each band. Also, one or more frequencies that cannot be reproduced by a given output device, e.g. the integrated speaker(s), can be rolled-off. Further, high-frequencies can be accentuated and the compressor can be switched into a mode to compensate for background noise. In some implementations, the DSP can be utilized for audio processing with respect to telephone communications, in addition to audio playback.

Additionally, the mobile device 200 can include a media button 220, which can be used to access media functionality. In some implementations, the media button 220 can be a multi-function button. For instance, a single press of the media button 220 can toggle the display between a media playback interface and the phone interface. Further, pressing and holding the media button 220 can cause an interface corresponding to the media service, e.g. a home menu, to be presented. The mobile device 200 can be configured such that accessing the media button 220 causes the corresponding media functionality to be presented, regardless of the previous function being performed and location within the device's command hierarchy. In some implementations, the functionality corresponding to media button 220 also can be state dependent. For instance, when media is playing, pressing the media button 220 can cause a music player interface to be displayed, while pressing and holding can cause the home screen of a remote media catalog (or store) to be displayed. The device 200 also can include physical controls for other functions, including volume and traversing back in the interface.

Also, in some implementations, a back button 222 can be included on the mobile device 200. When the back button 222 is included as a physical control on the device 200, software operating on the device 200 can allow a user to return to a preceding interface screen, upon pressing the back button 222.

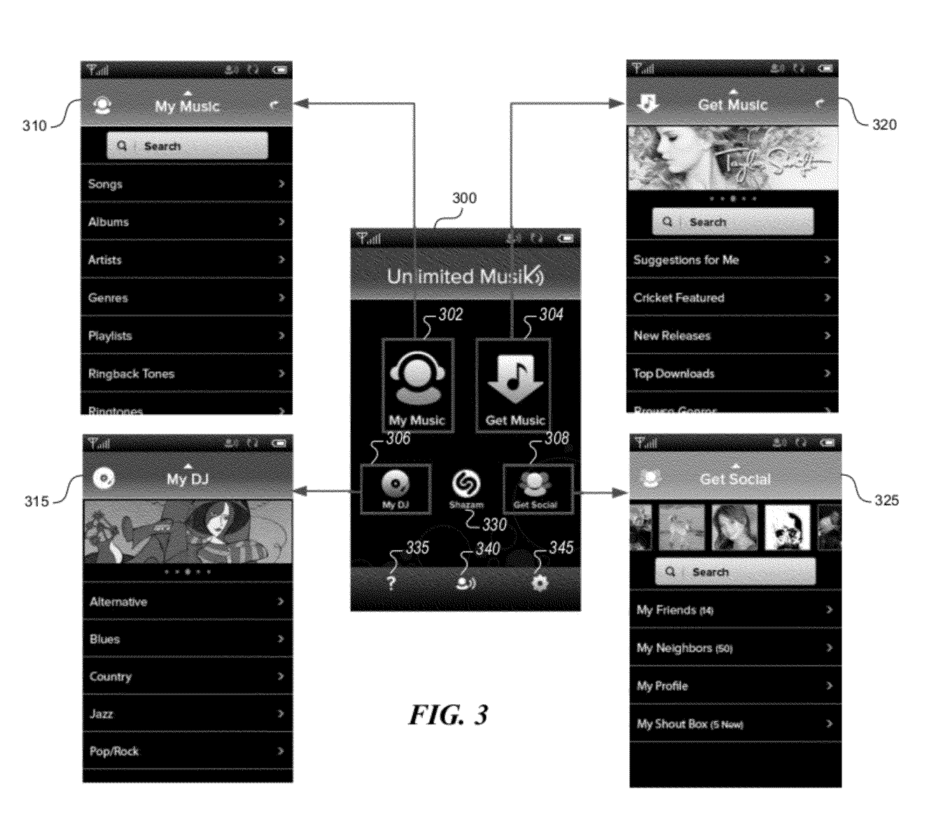

FIG. 3 shows an exemplary number of media interface screens associated with a media application that can be presented by the mobile device. The media interface screens can allow a newly subscribed user of a media distribution service, such as the one managed by server 105 to quickly populate an initial media library on the user's computing device, such as mobile device 220. Accordingly, the newly subscribed user can quickly obtain and access media content before having to learn the features of a media distribution system.

A home media interface screen 300 can be presented, which represents a top level of a multi-level application program. The home media interface screen 300 can show the name of the application, which in the exemplary screen 300 is shown as “Unlimited Musik.” At the top level, a user has access to several functional areas within the media application as well as access to one or more utilities. In the embodiment shown, the home media interface screen 300 includes a number of selectable icons corresponding to the various functional areas, including a “MyMusic” icon 302, a “GetMusic” icon 304, a “MyDJ” icon 306, and a “GetSocial” icon 308. An icon can be selected (or actuated) through any known technique, including through touch and cursor designation, voice activated command or the like. The icons presented are representative and other implementations can include fewer, more, and/or different icons.

The MyMusic icon (or button) 302 can be selected to present a local media interface screen 310, which can provide access to, and browsing of, the local media archive stored on the mobile device. The local media interface screen 310 includes a list of controls that can be selected by a user in order to navigate their way to different levels in the application. Each level allows the user to view the stored local media according to different criteria such as by song name, album name, artist name, genre of music, playlists, ringtones, and ringback tones. One or more other categories also can be included, such as music videos, television shows, and movies. Selecting an entry from the list presented on the local media interface screen 310 can cause the media application to present another level interface screen, hierarchically organized as a sub-interface that shows either the stored media corresponding to that category or a further list of selections to allow a user to view the local media archive according to additional criteria. The local media interface screen 310 also can include a search tool, which can be used to search the local media archive, e.g. using keyword searching.

The GetMusic icon 304 can be selected to present a remote media interface screen 320, corresponding to a remote music archive, content source or media store. The remote media interface screen 320 includes a list of controls that are selectable by the user to access and browse the remote media archive according to different criteria. For instance, in the embodiment shown, the remote media interface screen 320 includes one or more controls that allow the user to navigate to screens where the user can view the available media by song title, album title, artist name, genre, playlists, ringtones, and ringback tones. The remote media interface screen 320 also can include one or more other controls to allow the user to navigate to other screens showing personalized suggestions, featured media, new releases, and top downloads, e.g. for a predetermined period of time, such as a day, week, or month. Selecting a control from the remote media interface screen 320 can cause the media application to present another level interface screen, hierarchically organized as a sub-interface that shows media corresponding to the selected category or a list of selections to allow the user to view the media files stored at the remote media archive by additional criteria. The remote media interface screen 320 also can include a search tool, which can be used to search the remote media archive, e.g. using keyword searching.

The MyDJ icon 306 can be selected to present a playlist interface screen 315, which provides a list of controls that can be selected by the user to access and browse the playlists available to the mobile device. The playlists can include either or both of local playlists, e.g. generated by the user of the device, and remote playlists that are generated by an external provider, such as another user or the system operator. The playlist interface screen 315 includes a list of controls that allow the user to navigate to screens where the user can view the playlists by genre, content, and playlist source. For instance, the playlists can be viewed using genres such as alternative, blues, country, jazz, and pop/rock. Selecting a control from the playlist interface screen 315 can cause the media application to present another level interface screen, hierarchically organized as a sub-interface, that shows playlists corresponding to that category or another set of selections. In some implementations, the playlists shown can include playlists that are presently available, e.g. local playlists and subscribed playlists, and playlists that are not presently available but can be subscribed to. Further, the playlists that are presently available can be visually distinguished from those that are not, such as through highlighting or through the association of a graphical identifier.

The GetSocial icon 308 can be selected by the user to cause the media application to present a social interface screen 325, which can provide access to the subscriber's community. The community can include connected friends who also are subscribers to the media service, identified neighbors, and a Shout box that provides access to messaging within the media application and service. Further, the social interface screen 325 can provide access to the subscriber's profile, which can be used to describe and publicize subscriber characteristics, including musical preferences and the subscriber's local media archive. The social interface screen 325 also can include a search tool, which can be used to search the subscriber's social connections, e.g. using keyword searching.

Additionally, home media interface screen 300 can present one or more utility icons, which can be selected to perform operations corresponding to the media application. For instance, a music recognition icon 330 can be selected to capture audio and submit it to a music recognition service. Also, a help icon 335 can be selected to access help, e.g. instructions or demonstrations, relating to one or more features and functions of the media application. A help interface organized by topics, such as functions, can be presented in response to selection of the help icon 335. In some implementations, a full tutorial for the media application also can be accessed.

The Shout icon 340 can be selected to access a Shout interface screen presenting the subscriber's Shout message box. The Shout message box can include Shout messages to and between all members of the subscriber's community. Further, the Shout interface can include an option to view only Shouts addressed to the subscriber and/or sent by the subscriber. Additionally, the home media interface 300 can include a settings icon 345, which can be selected to view and alter one or more device and media application settings, including synchronization status settings, social settings, card settings, and parental controls.

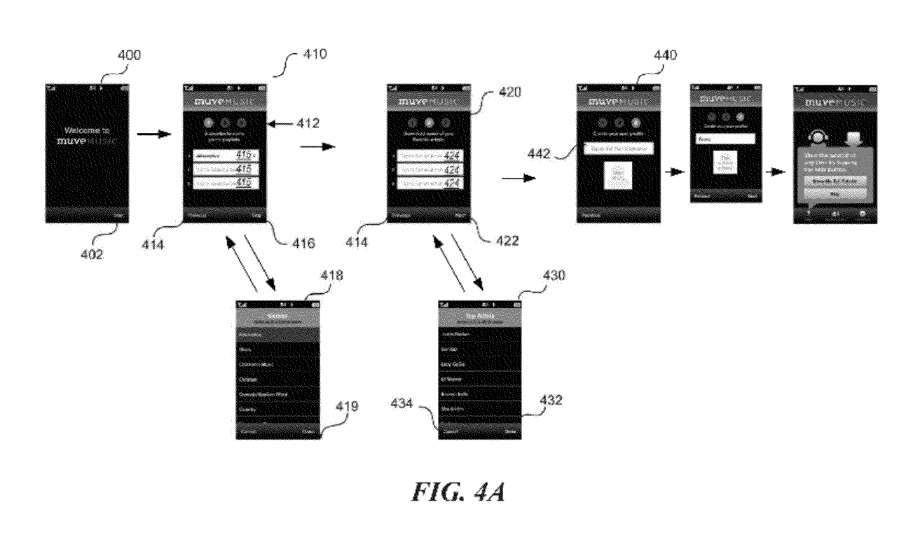

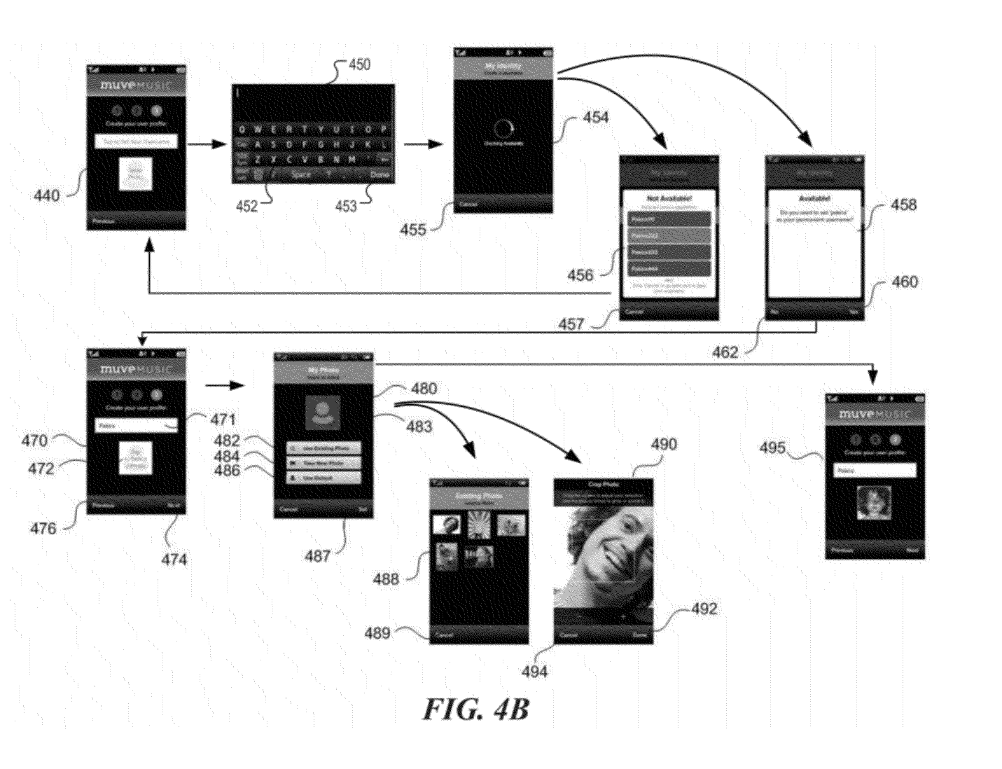

In order to populate a subscriber's local archive of media files, the media application arranges for the selection and download of a number of media files from the content source based on received user preference information. An initial library of content can be selected and downloaded to the local archive when the user first activates a subscription service or upon request by the user. FIGS. 4A and 4B show exemplary interface screens that can be presented by the media application to allow the subscriber to provide preference information indicative of one or more types of music or other content. In the example shown, an initial interface screen 400 can be presented when the subscriber first activates the media application. The interface screen 400 can show a title for the setup process, which in the illustrated embodiment is “Muve Music.” The interface screen 400 can also include a start control 402 that can be selected to cause the media application to begin the setup process.

Upon selection of the start control 402, the media application can present a genre selection interface 410. The genre selection interface 410 can include a progress bar or number of colored buttons 412 that are highlighted to indicate where the user is in the setup process and how many steps are required in order to complete the setup process. The genre selection interface 410 can also contain a control 414 labeled “Previous” that can be selected to cause the media application to return to the previous interface screen, e.g. the initial interface screen 400. A skip control 416 also can be provided that when selected causes the media application to skip the current stage of the setup process and to proceed to a next step.

In addition, the genre selection interface 410 can include a number of text boxes 415 labeled “1, 2, 3” in which different genres can be entered or selected. Selecting a text box can cause the media application to present an interface screen 418 that shows a list of the available genres that can be selected. The interface screen 418 can also include a control 419 labeled “Done” that when selected, causes the media application to return to genre selection interface 410. Further, when a genre is selected, that genre can be displayed in the previously selected text box 415 upon return to the genre selection interface 410. In other implementations, the media application program can use auto completion, suggestion, or spelling correction as the user enters text directly into a text box 415. In still other implementations, a list of available genre choices can be presented, e.g., in a drop-down menu format or can be enforced through auto completion. For example, a user can enter the first letter of a genre name into a text box and all matching genres available in the music service can be presented. The list of choices can be further narrowed through the addition of other letters in the genre name.

Once at least one genre is entered into a text box 415, the media application can cause the control 416 to be relabeled as “Next”. The user can then continue to select other genres using the one or more remaining text boxes or the user can select the next control 416 to cause the media application to present an artist interface 420. The artist interface 420 can include a number of text boxes 424 labeled “1, 2, 3” that can be used to specify artist information. For example, selecting one of the text boxes 424 can cause the media application to present an interface screen 430 that contains a list of available artists. In some implementations, the list of artists can correspond to one or more of the previously selected genres. For example, if a user previously selected “Alternative” as a genre in a text box 415, the media application can present a list of artists, e.g. the top 25 artists, that are classified by the subscription service as Alternative artists. Further, if multiple genres have been specified, the list of artists in the interface screen 430 can include one or more artists corresponding to each of the genres. For example, the top 25 artists from each genre can be included in the list. Once the user has selected an artist from the list, the user can select a done control 432 to cause the media application to return to the interface screen 420. The user can then use one or more of the remaining text boxes 424 to select other artists. Alternatively, the user can select a next control 422 to cause the media application to present an interface screen 440. In some implementations, the next control 422 also can be configured as a skip control until at least one artist has been specified. In some other implementations, a subscriber can be required to select at least one artist, e.g. if no genre was specified. The media content item selection process described in this document can be performed manually by the user or automatically created based on an algorithm that takes into account various factors, similar to those described above. For example, the described system can allow the user to fill the initial library on the user's MyMusic functional area using already existing media listing, such as suggested lists, top albums, top songs, newly released, and play lists of other users.

The setup process also can be configured to permit a subscriber to create a user profile. The profile can be initialized by selecting a user name and, optionally, by selecting a photograph or image to be associated with the user name. The profile interface 440 can include a text box 442 that when selected causes the media application to produce an interface screen 450 (FIG. 4B) with a number of controls 452 labeled and arranged as a QWERTY or other keyboard. The user can type in their desired user name using the controls that represent the keyboard. Upon selecting a done control 453, the media application can send a message to the media service to determine whether the user name that was entered is available. An interface screen 454 can be presented by the media application to inform the user that the media application is checking to determine if the selected user name is available. If the entered user name is not available, the media application can present an interface screen 456 that shows a list of similar user names that are available for use. If the user does not like any of the suggested names, the user can select a cancel control 457 to cause the media application to return to the interface screen 440 in order restart the process of selecting a user name.

Otherwise, if the entered user name is available, the media application can present an interface screen 458 with a message informing the user that the selected user name is available. The interface screen 458 can include a control 460 labeled “Yes” and a control 462 labeled “No” that can be selected to indicate whether the user wants to accept the user name that the user has entered as their permanent user name. If the no control 462 is selected, the media application can return to the interface screen 440 in order restart the process of selecting a user name.

Once the user has selected a permanent user name, the media application can present an interface screen 470 having a text box 471 that shows the user's selected name and a control 472 labeled “Tap to Select a Photo” that can be selected to cause the media application program to present an image interface 480. The interface screen 470 can also include a control 474 labeled “Next” that can be selected to cause the media application to proceed to the next step in the setup process without selecting a photograph. In addition, the interface screen can include a control 476 labeled “Previous” that can be selected to cause the media application to return to the previous interface screen, e.g. the artist interface 420.

The image interface 480 can also include a number of controls providing options for allowing a user to select a photograph to be associated with their profile. A control 482 labeled “Use Existing Photo” can be selected to cause the media application to present an interface screen 488 that displays a number of photographs from which the user can select. The photographs can be ones that the user has captured with a built-in camera, downloaded from another computer or from the Internet, or a number of stock photographs that are preloaded on the device. A control 484 labeled “Take New Photo” can be selected to cause the media application to activate an associated camera, e.g. in the device, to capture a new image. A view finder can be shown in an interface screen 490 that can include controls labeled “+” and “−” for zooming in and out to frame the photograph. Alternatively, a captured photograph can be presented in the interface screen 490 along with a crop control, such as an adjustable box and the “+” and “−” controls. Once the user is happy with the photograph, the user can select a done control 492 to cause the media application to present the interface screen 480 with the selected photograph at a position 483. Alternatively the user can select a cancel control 494 to cause the media application to return to the interface screen 480 without selecting a photograph. Additionally, a control 486 labeled “Use Default” can be selected to cause the media application to associate a default image with the selected user name. A set control 487 can be selected to associate the selected image with the profile and further can cause the media application to present a final profile interface 495 that shows the selected user name and associated image (if any), and signals that the set up process is complete.

Although the exemplary interface screens shown in FIGS. 4A and 4B prompt the user to enter information regarding their favorite genres and artists, it will be appreciated that additional, different, or less information can be requested to populate the local media archive during set up. For example, the application may prompt the user for any negative preferences such as “No Disco” or no songs prior to 1960, etc. Further, information can be collected in a different order in different implementations. For instance, artist information can be collected before genre information, and can be used to pre-select from or rank the available genres.

Once the user's preference information has been received, the computing device, e.g. a mobile communications device, can forward the preference information to the media service, e.g. server 105, that hosts the content source in order to select a number of song files or other media files for the user based on the preference information provided. For instance, tracks corresponding to the selected artists and genres can be selected for download to the local media archive. Further, the media service can use artificial intelligence or other techniques to select additional content for download to the local media archive. For example, a selection can be based on statistical factors such as “75% of subscribers who downloaded song X also have downloaded song Y” or “88% of subscribers who download songs by artist M also download songs by artist N,” etc. The statistical factors can be factors collected by the media service, factors received from other parties, such as ranking services, or a combination thereof. Alternatively or additionally, more sophisticated analyses can be performed by determining beat patterns, instrument selections, vocal styles or a number of other metrics associated with the artists or genres indicated by the preference information received from the user and those metrics can be compared against the content available through the media service.

The amount of content selected by the music service for download to the subscriber's local archive also can be determined, at least in part, by the size of the memory available to store the local archive. For example, the size of the initial local archive can be selected such that the library occupies no more than some predefined percentage (e.g., 50%) of the free memory available. As a result, the subscriber can be provided with the remainder of the archive to store content they have expressly selected. The music service can be configured to monitor the size of the local archive and the amount of storage available to prevent over-loading.

One or more techniques also can be used to manage the transfer of content associated with establishing the initial local archive. Because media files can be large and many files can be selected for downloading to establish the local archive, the transfer of the selected media files can be managed to preserve a receiving device's battery power and to control when cellular bandwidth is utilized for over the air transfer. In some implementations, an initial portion, e.g. 10-20%, of the content selected by the set-up process can be downloaded immediately, so that the archive is populated with some content, and the remaining content can be transferred in accordance with one or more conditions. For example, the mobile device can request files to be downloaded when the device is not occupied with requesting/receiving data from another source and is not being used for other communications functions, e.g. a telephone call. Additionally, files can be downloaded when the mobile device is connected to an external power supply or when the battery level of the mobile device is above a threshold charge level (e.g. >75%). Also, content can be downloaded when the mobile device is connected to a non-cellular communications link, such as a Wi-Fi connection. Further, content can be downloaded at “off-peak” times for network traffic, such as after 11 p.m. and before 8 a.m.

By arranging the transfer of media files from the subscription service to the mobile device at times when network traffic is reduced and when sufficient power is available, unnecessary over the air cellular bandwidth may be used and/or reserve battery power may be conserved. In some embodiments, the mobile device may coordinate with the subscription service to immediately download a small number of the selected media files in the initial library with the balance or remainder to be downloaded at a later time.

The setup process also can be initiated at any time in response to a subscriber request. For example, the subscriber can enter run the set-up process using completely different preference information to obtain new content. Further, additional preference data can be specified to refine the automatic selection of files for the local archive. Data including play counts, ratings of media files, preference information of the friends and neighbors, etc. can be used to manage the local archive. For instance, additional songs or media files can be selected and downloaded to the local archive based, at least in part, on the additional data. Also, songs or other media files that have been played less than a predetermined number of times or given low ratings by the user can be removed from the local archive. In this way, the media service can dynamically learn the user's preferences as the user continues to interact with the service and can update the files that are stored in the local archive accordingly.

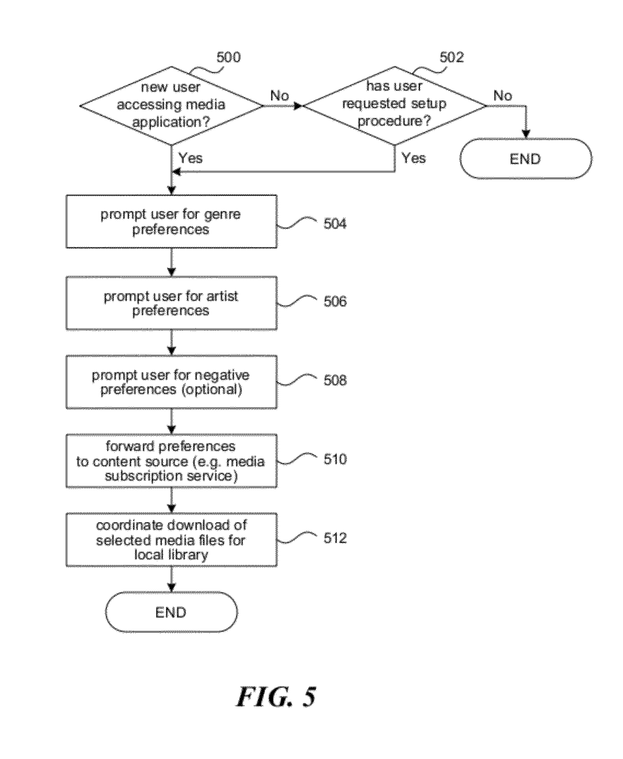

FIG. 5 illustrates one exemplary series of steps that may be performed by a processor within the mobile device that implements the media application in order to complete a setup process and receive a library of media files. Although the steps are shown in a particular order for ease of explanation, it will be appreciated that the steps could be performed in a different order or different steps performed and still achieve the functionality described.

Beginning at 500, the processor can determine if a new user is accessing the media application. If not, the processor can determine at 502 if a user has requested a setup procedure. If the answer to either step 500 or 502 is yes, the processor can prompt the user for one or more items of preference information. In some implementations, the user can be prompted for one or more genre preferences at 504 and artist preferences at 506. In some implementations, the processor also may prompt the user to enter one or more negative preferences or other preference information at 508.

Once the preference information is obtained, the processor can forward the preference information to the subscription service at 510, which can use the preference information received to select a library of music/media files for the user. The mobile device and the subscription service can coordinate when the files in the initial library should be downloaded for storage in a local media archive of the mobile device at 512.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium also can be, or can be included in, one or more separate physical components or media (e.g., multiple CDs, disks, or other storage devices). The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display), LED (light emitting diode), or OLED (organic light emitting diode) monitor, for displaying information to the user and a keyboard and a pointing device, e.g., a mouse or a trackball, by which the user can provide input to the computer. In some implementations, a touch screen can be used to display information and to receive input from a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include any number of clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

As will be appreciated, the technology disclosed herein provides a simple and easy mechanism to allow a library of media files to be stored on a mobile device without a user having to select each content file individually. In addition, the library can be downloaded in a manner that reduces battery usage of the mobile device and/or over the air bandwidth.

From the foregoing, it will be appreciated that specific embodiments of the invention have been described herein for purposes of illustration, but that various modifications may be made without deviating from the spirit and scope of the invention. For example, although the content source described in the disclosed embodiments is a music subscription service, the disclosed technology is equally applicable to more traditional online sellers of media files, such as services where a user pays for each media file that is downloaded. In addition, the disclosed technology is not limited to creating a library of music files. Libraries can be created of video clips, TV shows, movies, books or any other digital content. Furthermore, the library created is not limited to being an initial library that is stored on a mobile device. For example, a user may have already selected a number of individual songs, albums or other media files to store on the mobile device. The disclosed technology can then be used to augment or replace the library of files that is stored on the mobile device.

Accordingly, the invention is not limited except as by the appended claims.

What is claimed is:

1. A device, comprising:
an input device configured to receive input;
an output device configured to play media files;
a storage device configured to store a library of media files; and
processor electronics configured to perform operations comprising:
receiving preference information;
forwarding the preference information to a content source to select a number of media files to include in the library of media files; and
storing in the storage device, a number of the selected media files that are downloaded from the content source.

2. The device of claim 1, wherein the processor is further configured to perform operations comprising requesting that the content source download one or more of the selected media files when the device is powered with an external power supply.

3. The device of claim 1, wherein the processor is further configured to perform operations comprising requesting that the content source download one or more of the selected media files when the device is connected to the content source through a non-cellular communication link.

4. The device of claim 1, wherein the processor is further configured to perform operations comprising coordinating with the content source to download one or more of the selected media files when a level of traffic on a communication channel that connects the device to the content source is below a threshold.

5. The device of claim 1, wherein the processor is configured to perform operations comprising coordinating with the content source to immediately download one or more of the selected media files and to delay downloading a remainder of the selected media files.

6. The device of claim 1, wherein the processor is further configured to perform operations comprising:
recording rating data of media files in the library;
sending the rating data to the content source; and
receiving an updated library of media files based in part on the recorded rating data.

7. The device of claim 6, wherein the rating data indicates a number of times selected media files in the stored library have been played.

8. A computer system configured to provide a selection of media files as a library of media files to a mobile device, comprising:
processor electronics configured to perform operations comprising:
receiving preference information from a mobile device;
selecting a number of media files to include in the library of media files based on the received preference information; and
downloading the selected media files to the mobile device for storage on the mobile device.

9. The computer system of claim 8, wherein the processor is further configured perform operations comprising coordinating with the mobile device when one ore more of selected media files will be downloaded to the mobile device.

10. The computer system of claim 9, wherein the processor is configured to perform operations comprising receiving an indication that the mobile device is connected to an external power supply and downloading one or more of the selected media files to the mobile device when the mobile device is connected to an external power supply.

11. The computer system of claim 9, wherein the processor is further configured to perform operations comprising downloading one or more of the selected media files to the mobile device when traffic on a communication channel that connects the computer system to the mobile device is below a threshold level.

12. The computer system of claim 8, wherein the processor is further configured to perform operations comprising storing a record of media files subsequently downloaded to the mobile device after the library of media files has been downloaded to the mobile device and to update the library of media files based on the record of media files subsequently downloaded.

13. The computer system of claim 8, wherein the processor is further configured to perform operations comprising selecting a number of media files for the library based on an amount of memory available on the mobile device.

14. A non-transitory, computer readable media containing instructions that are executable by a processor of a mobile device to perform operations comprising:
receiving preference information;
forwarding the preference information to a content source to select a number of media files to include in a library of media files in response to the received preference information; and
storing the selected media files received from the content source in a memory of the mobile device.

15. The non-transitory, computer readable media of claim 14, further comprising instructions that are executable by the processor of the mobile device to perform operations comprising:
coordinating with the content source when a number of selected media files will be downloaded to the mobile device.

16. The non-transitory, computer readable media of claim 15, further comprising instructions that are executable by the processor of the mobile device to perform operations comprising:
coordinating with the content source to download one or more of the selected media files when traffic on a communications network that connects the mobile device to the content source is below a threshold level.

17. The non-transitory, computer readable media of claim 15, further comprising instructions that are executable by the processor of the mobile device to perform operations comprising:
coordinating with the content source to immediately download one or more of the number of selected media files to the mobile device and to delay the download of a remainder of the number of selected media files.

18. The non-transitory, computer readable media of claim 15, further comprising instructions that are executable by the processor of the mobile device to perform operations comprising coordinating with the content source to download one or more of the selected media files when the mobile device is connected to an external source of power.
